(19) United States
(12) Patent Application Publication
(10) Pub. No.: US 2015/0183943 A1
(43) Pub. Date: Jul. 2, 2015

(54) COMPOSITE MATERIAL

(71) Applicant: NANYANG TECHNOLOGICAL UNIVERSITY, Singapore (SG)

(72) Inventors: Evren Mutlugun, Singapore (SG); Hilmi Volkan Demir, Singapore (SG)

(21) Appl. No.: 14/409,960

(22) PCT Filed: Jun. 18, 2013
(86) PCT No.: PCT/SG2013/000251

§ 371 Date: Dec. 19, 2014

Related U.S. Application Data
(60) Provisional application No. 61/662,068, filed on Jun. 20, 2012.

(51) Int. Cl. C08J 5/18; B29C 39/10

(52) U.S. Cl. CPC C08J 5/18; B29C 39/10; B29K 2033/12

(57) ABSTRACT

There is herein disclosed a composite material comprising nanoparticles capped with a hydrophobic ligand dispersed within a polymer matrix. The hydrophobic ligand is a fatty acid and/or selected from (R¹)₃P, (R²)₃P(O), R³P(O)(OH)₂, R⁴NH₂, R⁵—CO₂H and mixtures thereof, wherein: R¹ to R³ each independently represents a C₈ to C₂₄ straight- or branched-chain alkyl group that is saturated or unsaturated; R⁴ represents a C₁₄ to C₂₄ straight- or branched-chain alkyl group that is saturated or unsaturated; and R⁵ represents a C₁₂ to C₂₄ straight- or branched-chain alkyl group that is saturated or unsaturated, and methods for making the same.

### FIELD OF THE INVENTION

This invention relates to composite materials comprising nanoparticles dispersed within a polymer matrix and applications thereof.

### BACKGROUND

The listing or discussion of a prior-published document in this specification should not necessarily be taken as an acknowledgement that the document is part of the state of the art or is common general knowledge.

Nanoparticle polymer matrix composites are a relatively new field of study, with a number of interesting applications, which include optical and magnetic properties, microelectronic devices, piezoelectric actuators and sensors, electrolytes, anodes in lithium-ion-batteries and supercapacitors, organic solar cells and intrinsic conductive polymers, photoresists used in microelectronics and microsystems technologies and applications in the biomedical sciences (see, for example, Hanemann et al. Materials 2010, 3, 3468-3517). However, there remains a need for new nanoparticle composite materials with improved properties. This is especially true for quantum dot (QD) composite materials, especially in relation to the production of high-quality free standing films with good optical properties.

In the past few decades semiconductor colloidal quantum dots (QDs), also known as nanocrystals, have attracted substantial interest for device applications including light emitting diodes (LEDs), which are important for solid-state lighting (see, for example, Jang, E. et al. Adv. Mater. 2010, 22, 3076-80; Erdem, T. et al. Nat. Photon. 2011, 5, 126 and Panda, S. K. et al. Angew. Chem., Int. Ed. 2011, 123, 1). The demand for these QD particles has risen as a result of their favorable electronic and optical properties. For example, the band gap engineering of the QDs can be conveniently achieved by tuning the particle size, which has made semiconductor QDs versatile in device applications (e.g. Konstantatos, G. et al. Nature 2006, 442, 180-3 and Michalet, X. et al. Science 2005, 307, 538-44).

Previous disclosures of QD solids in polymer matrices relate mostly to type II-VI Cd-based materials, which have been extensively studied for their use in polymers in order to benefit from the advantageous properties of the polymer (e.g. see Lee, J. et al. Adv. Mater. 2000, 12, 1102-110, Zhang, H. et al. Adv. Mater. 2005, 17, 853-857 and Neves et al. Nanotechnology 2008, 19, 155601). By incorporating QDs into a polymeric film, the QDs gain elasticity and processability, which they cannot provide in their as-synthesized form (e.g. Xiong, H.-M. et al. Adv. Func. Mater. 2005, 15, 1751-1756). However, solid film formation from colloidal QDs in solution is challenging and requires a high level of understanding of the behaviour of the complex mixtures formed by QDs in order to achieve films of high optical quality. This is because colloidal QDs are commonly synthesized in solution and the ability to transfer them from dispersion in solution to solid form, e.g., in polymeric host media, is essential from a typical device application point of view. This is a particularly important consideration when attempting to provide composite QD materials that have a large area (e.g. =10 cm×10 cm, such as =50 cm×50 cm).

The optimal QD film should be capable of standing alone (i.e. freestanding), provide versatility, flexibility, and mechanical strength and be able to be fabricated over large areas. These requirements presently drive the strong research efforts into stand-alone flexible films of QDs.

Based upon recent extensive research activities on large-area flexible electronics (Rogers, J. A. et al. Proc. Natl. Acad. Sci. 2001, 98, 4835-4840), it appears that the implementation of QD based materials in large-area systems is highly desirable for use in matching large-area optoelectronic devices including light engines, displays, photovoltaics and sensors.

Tetsuka et al. (Adv. Mater. 2008, 20, 3039-3043) reported flexible clay films of Cd-containing QDs. In this report, the resulting films were small in size, required ligand exchange of the QDs and also preparation of a clay suspension.

Lee et al. (Adv. Mater. 2000, 12, 1102) discloses CdSe/ZnS QD composites, which are shaped as rods having 6 cm length and 0.5 cm diameter. However, while the material is described as providing full colour emission, no performance data for the composite is provided.

Neves et al. (ibid.) have developed flexible films containing CdSe/ZnS QDs within a sol-gel matrix. However, the films produced by Neves were in the size range of a few cm's.

Zhang and colleagues (ibid.) have also studied the use of functional polymers together with CdTe QDs for the formation of different geometrical shapes. Their work further demonstrated the preparation of microspheres of QD containing composites. However, again the resulting film sizes were limited.

Weaver et al. (J. Mater. Chem. 2009, 19, 3198-3206) discloses a QD polymer composites with different patterned shapes, each having an area around 5 cm×5 cm.

Although these previous disclosures have provided new techniques for the formation of QD-polymer composites, there remains a need for freestanding QD composite materials with a large area (e.g. =10 cm×10 cm, such as =50 cm×50 cm). This is because the previous disclosures mentioned above are limited to small-area demonstrations of NC films (typically under 25 cm²), the recipes for fabricating optically uniform, standalone films or structures of polymer-NCs have not been studied for large-area applications, nor have their mechanical properties been investigated to see if they are suitable for versatile use. While a polymer matrix may provide superior properties to the embedded NCs, the fabrication procedures are commonly complicated and require ligand exchange and chemical treatments reducing the quality of quantum dots and restricting the application perspectives of the composites.

Today while the research on Cd-based colloidal QDs (e.g., CdSe, CdTe, CdSe/CdS, and CdSe/ZnS) is quite mature with respect to their synthesis and applications (e.g. see Yang, Y. A. et al. Angew. Chem. Int. Edt. 2005, 117, 6870; Peng, Z. A. et al. J. Am. Chem. Soc. 2001, 123, 183; Manna, L. et al. J. Am. Chem. Soc. 2000, 122, 12700; Gaponik, N. et al. J. Phys. Chem. B. 2002, 106, 7177; Dabbousi, B. O. J. Phys. Chem. B. 1997, 101, 9463; Demir, H. V. et al. Nano Today 2011, 6, 632; Cicek, N. et al. Appl. Phys. Lett. 2009, 94, 061105.) is quite mature with respect to their synthesis and applications, recent research on In-based QDs has mainly focused on the synthesis methodology and understanding of the growth mechanisms and crystal structure of these materials (Ryu, E. et al. Chem. Mat. 2009, 21, 2425; Xie, R. et al. J. Am. Chem. Soc. 2007, 129, 15432; Thuy, U. T. D. et.al., Appl. Phys. Lett. 2010, 96, 073102; Pham, T. T. et al. Adv. Nat. Sci: Nanosci. Nanotechnol. 2011, 2, 025001; Thuy, U. T. D. et al. Appl. Phys. Lett. 2010, 97, 193104; Li, L. et al. J. Am. Chem. Soc. 2008, 130, 11588; Ziegler, J. Adv. Mater. 2008, 20, 4068). Moreover, the use of In-based QDs for various applications has not been investigated much except for a few reports that discuss lasing possibilities and imaging of cells (Gao, S. et al. Opt. Exp. 2011, 19, 5528; Yong, K.-T. et al. ACS Nano 2009, 3, 502)).

Nevertheless, even for Cd-based QDs, there is a need to obtain improved composite materials, especially materials with a large area. Furthermore, from an ecological point of view, the use of Cd-free QDs such as those based on InP would enable eco-friendly applications and research into supplanting the dominant Cd-based QDs is currently a hot topic.

### SUMMARY OF INVENTION

The current invention relates to composite materials comprising nanoparticles dispersed within a polymer matrix. In this regard, it is desirable that the composite material is much simpler in design and construction than earlier materials. For example, it is desirable that the material does not require anything special in order to function and also does not require chemical integration steps in its production. Thus it may be desirable to avoid the need for ligand exchange or complicated chemical cooperation. A desirable feature for a composite material according to the current invention is the ability for two or more layers of composite material to be laid on top of each other to generate a multi-layered composite material. A further desirable feature of composite materials of the invention is the ability for the material to stretch, therefore enabling its use on three-dimensional surfaces and potentially making the composite material of the invention wearable.

In a first aspect of the invention, there is provided a composite material comprising nanoparticles capped with a hydrophobic ligand dispersed within a polymer matrix. The hydrophobic ligand may be a fatty acid and/or selected from (R¹)₃P, (R²)₃P(O), R³P(O)(OH)₂, R⁴NH₂, R⁵CO₂H and mixtures thereof, wherein R¹ to R³ each independently represents a C₈ to C₂₄ straight- or branched-chain alkyl group that is saturated or unsaturated; R⁴ represents a C₁₄ to C₂₄ straight- or branched-chain alkyl group that is saturated or unsaturated; and R⁵ represents a C₁₂ to C₂₄ straight- or branched-chain alkyl group that is saturated or unsaturated.

As fatty acid ligands may be used in the synthesis of QDs, liphophilic polymers may also be compatible.

In a second aspect of the invention, there is provided a composite material comprising InP/ZnS quantum dots capped, with a fatty acid ligand dispersed within a, polymer matrix of polymethylmethacrylate (PMMA). The fatty acid ligand may be Myristic acid (MA) and/or Stearic acid (SA).

In a third aspect of the invention, there is provided a use of the composite materials of the first and/or second aspect in one or more of light generation, light harvesting and light sensing and in matching optoelectronic devices, optoelectronic devices and sensors.

In a fourth aspect of the invention, there is provided a device suitable for light generation, light harvesting and light sensing comprising a composite material of the first or second aspects.

In a fifth aspect of the invention, there is provided a method of making a composite material, comprising:

(a) mixing a polymer and a nanoparticle capped with a hydrophobic ligand together in at least one solvent;

(b) depositing the resulting mixture, or a portion thereof, onto a substrate;

(c) allowing the solvent to evaporate to form the composite material; and

(d) removing the composite material from the substrate in substantially one piece.

Most solution-based processing methods may be used for film formation. For example drop casting, spin coating, ink-jet printing, dip coating, moulding, stamping, imprinting, doctor blading, air spraying, layer-by-layer assembly, Langmuir Blodgett coating, etc. Removing the film may be done manually, or using customized tools or robotics. This may be done depending on the requirements, to prevent tearing apart the film when peeling off, especially in thinner films.

The composite material may be a film.

The film may be a multi-layered film having at least two layers; it may have a surface area of greater than or equal to 50 cm×50 cm; and/or it may be a free standing film.

A contact angle of a water droplet on the film may be greater than or equal to 85° and less than 180° using the a static sessile drop test.

No substantial cracking or deterioration may be observable in the film.

R1 to R3 may each independently represent a C10 to C16 straight- or branched-chain alkyl group that is saturated or unsaturated; R4 may represent a C16 to C18 straight- or branched-chain alkyl group that is saturated or unsaturated; and R5 may represent a C14 to C18 straight- or branched-chain alkyl group that is saturated or unsaturated.

R1 to R5 may each independently represent straight-chain alkyl groups.

The hydrophobic ligand may be selected from the group consisting of Myristic acid (MA), Stearic acid (SA), Trioctylphosphine oxide (TOPO), Tetradecylphosphonic acid (TDPA), Trioctylphosphine (TOP), Oleic acid (OA), Octylphosphonic acid (OPA), Hexadecylamine (HDA), Octadecylphosphonic acid (ODPA) and any combination thereof.

The polymer matrix may be selected from the group consisting of Polydimethylsiloxane (PDMS), Polymethylmethacrylate (PMMA), Polystyrene (PS), Polyethyleneglycol (PEG), Polyvinylalcohol (PVA) and any combination thereof.

The nanoparticles may be selected from the group consisting of quantum dots, semiconductor materials, metals and metal oxides.

The quantum dots may be selected from the group consisting of one or more of CdSe, CdS, CdTe, PbS, PbSe, ZnS, ZnSe, InP, InAs, CdHgTe, CdSe/CdS, CdSe/ZnS, CdSe/CdS/ZnS, CdTe/CdSe, CdTe/Cds, ZnSe/ZnS, CdTe/ZnS, InP/ZnS, InP/GaP/ZnS and any combination thereof.

The nanoparticles may be dispersed homogeneously throughout the polymer matrix.

The nanoparticles may have a diameter of from 1 to 20 nm.

The fatty acid ligand may be Myristic acid (MA) and/or Stearic acid (SA).

The solvent may be selected from the group consisting of an alkane solvent, an aromatic solvent and a heterocyclic solvent.

The polymer may be PMMA and is dissolved in anisole; and/or the nanoparticles may be QDs suspended in toluene and/or hexane.

The nanoparticles may be provided in a colloidal suspension having a concentration from 1 to 1000 μM.

The nanoparticles may be cleaned with at least one solvent to remove excess organic ligands.

The substrate may be precleaned to remove any impurities from its surface.

The substrate may be a glass substrate.

The mixture of polymer, nanoparticles and solvent may drop-cast onto the substrate at a pre-determined ratio of from 0.2 mL per 10 cm² to 2 mL per 10 cm².

The method may form a multi-layered film, further comprising:

(i) mixing a polymer and a nanoparticle capped with a hydrophobic ligand together in at least one solvent;

(ii) depositing the resulting mixture, or a portion thereof, onto a previously formed composite material;

(iii) allowing the solvent to evaporate to form a further layer of composite material; and

(iv) repeating until the required number of layers have been deposited, wherein (i) to (iv) follow (c) and precede (d).

The film may be UV cured or annealed to further integrate the layers together before peeling the resulting multilayer film from the substrate.

Removing may comprise manual or automated peeling of the composite material from the substrate.

### BRIEF DESCRIPTION OF DRAWINGS

One or more embodiments will be described with the reference of the below drawings, in which:

FIG. 1 is a photograph of a 51 cm×51 cm InP/ZnS QD film under room light along with a ruler (left) and the folded film under UV illumination (right).

FIG. 2 is a chemical structure diagram of the myristic acid (left) and PMMA (right).

FIG. 3 is a fluorescence microscopy image of the InP/ZnS QD-PMMA film (Inset: the emission spectrum 6 of the same film).

FIG. 4 are TEM images showing the distribution of InP/ZnS QDs in the PMMA matrix: a) close to the edge of the film cross-section on the TEM grid, with said cross-section showing 7 and b) an exemplary location at an inner point across the thickness of the cross-section, as is repeated at other locations (Here the scale bar is 5 nm).

FIG. 5 is a flow diagram of the process for preparing a drop-cast film as a single layer or as a multi-layered film according to an aspect of the invention. The steps being set out in sequence and labeled 100 to 107.

FIG. 6 is a flow diagram of the process for preparing the film of Example 1. The steps being set out in sequence and labeled 200 to 205.

FIG. 7 is a graph of the electroluminescence spectra of a proof-of-concept white LED using InP/ZnS QD film as the remote color-converting nanophosphors together with a blue LED chip. Also an exemplary device under operation is shown on the right, labeled 700.

FIG. 8 is a graph of the stress-strain measurement of a 35 μm thick InP/ZnS QD-PMMA film.

FIG. 9 is a graph of the absorbance spectra of the InP/ZnS QD-PMMA films at various positions.

FIG. 10 is an image of the contact-angle measurements of the freestanding InP/ZnS QD film 400, which has a contact angle of ˜90° (based upon water droplet 401), show an enhanced hydrophobicity, over that of the PMMA only film 402 which has a nominal contact angle of ˜80° (based upon water droplet 403).

FIG. 11 is a graph of the XPS spectra of the InP/ZnS quantum dot only (a) for carbon and (b) for oxygen analysis, XPS spectra of the PMMA only (c) for carbon and (d) for oxygen analysis and XPS spectra of the composite film (e) for carbon and (f) for oxygen analysis.

FIG. 12 is a graph of the normalized photoluminescence (solid line) and absorption (dashed line) spectra of the donor and acceptor InP/ZnS QDs (Inset: transmission electron microscopy (TEM) image 1200 of the InP/ZnS QDs—the scale bar is 5 nm).

FIG. 13 is a graph of the time resolved photoluminescence (TRPL) spectra decay profile of the film donor QDs without (w/o) acceptors (top) and the donor QDs with the acceptor QDs (bottom), all measured at the donor emission wavelength of 490 nm, as a function of decreasing sample temperature. The exponential fits of the observed decays for the donors (with and without the acceptors) are also given. The inset 1300 shows the photoluminescence lifetime vs. temperature.

FIG. 14 is a graph of the temperature dependent photoluminescence intensity of the donor (top) and acceptor (bottom) quantum dots, extracted from the time-resolved photoluminescence measurements. The photoluminescence intensity is extracted using the same time interval for the photon counts.

FIG. 15 is a graph of the (A) Time resolved photoluminescence (TRPL) spectra of the acceptor without (w/o) donor (at 590 nm); (inset) the acceptor lifetimes (with and without donor) at 590 nm. (B) TRPL of the acceptor with donor (at 590 nm). (C) TRPL of the acceptor (without donor) (at 640 nm, far from the donor emission tail); (inset) the acceptor lifetimes (with and without donor) at 640 nm. (D) TRPL of the acceptor (with donor) (at 640 nm). All curves and data are given as a function of the temperature and the lifetimes are fit with triple exponentials.

FIG. 16 is a graph of the steady-state room temperature photoluminescence spectra of the films of the donor only 1603, the acceptor only 1601 and the hybrid film 1602. The inset 1600 shows the same steady-state room temperature photoluminescence spectra of the donor only 1603, the acceptor only 1601 and the hybrid film 1602 where the hybrid emission is fit to the donor and acceptor emissions as Gaussian curves.

FIG. 17 is a graph of the TGA analysis of the a) InP/ZnS QD-PMMA film and b) PMMA only film (reference sample) for the control experiment.

FIG. 18 is a graph of the XPS spectra of the InP/ZnS QD-PMMA film. The overall survey being shown by survey spectrum 1800.

FIG. 19 is a graph of the FRET efficiencies as a function of temperature: theoretical calculation (circles) and experimental data (squares).

### DETAILED DESCRIPTION

As discussed above, there remains a need for a composite nanoparticle material that can be fabricated over a large area and which is simple to make. This is especially the case given the ongoing extensive research efforts into large-area flexible electronics. Therefore, the implementation of composite nanoparticle materials (e.g. QD-based) in large-area systems is important for future large-area optoelectronic device applications including sensor arrays, solar conversion films and large-area displays, in addition to the surface lighting platforms.

In an embodiment, there is disclosed a composite material comprising nanoparticles capped with a hydrophobic ligand dispersed within a polymer matrix. The hydrophobic ligand may be a fatty acid and/or selected from (R¹)₃P, (R²)₃P(O), R³P(O)(OH)₂, R⁴NH₂, R⁵CO₂H and mixtures thereof. R¹ to R³ can each independently represents a C₈ to C₂₄ straight- or branched-chain alkyl group that is saturated or unsaturated. R⁴ can represent a C₁₄ to C₂₄ straight- or branched-chain alkyl group that is saturated or unsaturated. R⁵ can represent a C₁₂ to C₂₄ straight- or branched-chain alkyl group that is saturated or unsaturated.

Unless otherwise specified, alkyl groups as defined herein may be straight-chain or, when there is a sufficient number (i.e. a minimum of three) of carbon atoms, be branched-chain. Such alkyl groups may also be saturated or, when there is a sufficient number (i.e. a minimum of two) of carbon atoms. Unless otherwise specified, alkyl groups may also be substituted by one or more halo, and especially fluoro, atoms.

The term “halo”, includes chloro, bromo, iodo and, particularly, fluoro.

Embodiments may relate to the composite material being in the form a rod, a sphere or, more preferably, a film (e.g. a monolayer film or a multi-layered film having at least two layers). For example, when the composite material is a film, the film may have a thickness of from 20 μm to 80 μm (e.g. 30 μm to 70 μm, such as from 35 μm to 65 μm).

The thickness of the film depends on the particular requirements of a given application. For example the film thickness range can broadly range from 10 nm to 100 μm.

In yet further embodiments, when the composite material is a film, the film has a surface area of greater than 10 cm×10 cm (e.g. greater than or equal to 50 cm×50 cm). In yet further embodiments, the film is a free standing film. For example, a large-area free standing film 1, 2 having a size of 51 cm×51 cm is shown in FIG. 1.

In yet still further embodiments, when the composite material is in the form of a film, the contact angle of a water droplet is greater than or equal to 85° and less than 180° using the static sessile drop test (e.g. from greater than or equal to 90° to 120°). As will be appreciated, for different nanoparticles and/or polymers a different contact angle may be appropriate. Such a contact angle for the composite materials of the invention implies that the composite material can be removed from a substrate in substantially one piece, which enables the composite material to be used to form uniform, large-area free standing films. Therefore, in yet further embodiments of the invention, when the composite material is in the form of a film, it can be peeled off in substantially one piece from a substrate following manufacture. After peeling, no substantial cracking or deterioration was observable.

Peeling may be a manual or automated process. The force, angle, speed, direction, attachment, and/or temperature may be selected to suit the requirements of a given application. For example too fast peeling may result in the tearing of the sheet fabricated. In some case it may be appropriate to select an optimal “uniform force per unit time”.

After peeling the durability of the free standing film may be defined in terms of stress-strain characterization to characterize the elasticity. Young Modulus is a figure of merit for the stiffness of an elastic material. In either case optimal parameters will depend on a given application.

The homogeneity of the films can be used as a parameter that the films are uniform. Absorbance measurements can also be used to determine the quality of the resulting film. In either case optimal parameters will depend on a given application.

To determine the level of hydrophobicity, the contact angle measurement is a standard method performed by viewing and capturing the contact angle that a single water drop makes with the surface in the horizontal. The optimal level of hydrophobicity will depend on the material system, the substrate and the requirements of a given application.

In yet further embodiments of the invention, wherein the hydrophobic ligand is selected from (R¹)₃P, (R²)₃P(O), R³P(O)(OH)₂, R⁴NH₂, R⁵CO₂H and mixtures thereof, R¹ to R³ each independently represents a C₁₀ to C₁₆ straight- or branched-chain alkyl group that is saturated or unsaturated; R⁴ represents a C₁₆ to C₁₈ straight- or branched-chain alkyl group that is saturated or unsaturated; and R⁵ represents a C₁₄ to C₁₈ straight- or branched-chain alkyl group that is saturated or unsaturated. For example, R¹ to R⁵ may each independently represent straight-chain alkyl groups. In a particular embodiment, R⁵ is a saturated, straight-chain alkyl group.

In yet further embodiments of the invention, the hydrophobic ligand is selected from one or more of Myristic acid (MA), Stearic acid (SA), Trioctylphosphine oxide (TOPO), Tetradecylphosphonic acid (TDPA), Trioctylphosphine (TOP), Oleic acid (OA), Octylphosphonic acid (OPA), Hexadecylamine (HDA) and Octadecylphosphonic acid (ODPA) (e.g. the hydrophobic ligand is Myristic acid (MA) and/or Stearic acid (SA)). The chemical structure of myristic acid 3 is provided in FIG. 2.

In the large-area sheet demonstration, MA is used as the ligand of the QDs for the demonstration of the large area membrane. SA was also used to form free-standing membranes.

As the bottom layer forms the interface between the film and the surface, it may be that only the bottom layer should be hydrophobic for successful peeling. It may not necessary to have the top layer to be hydrophobic. However, each layer should have a reliable interface with the adjacent layers respectively. This may be achieved by using the same or similar chemistry.

The polymer matrix comprises one or more polymers selected from of Polydimethylsiloxane (PDMS), Polymethylmethacrylate (PMMA), Polystyrene (PS), Polyethyleneglycol (PEG), Polyvinylalcohol (PVA) (e.g. the polymer matrix comprises PMMA). The repeating unit of PMMA 4 is provided in FIG. 2.

The nanoparticles are selected from quantum dots, semiconductor materials, metals and metal oxides. For example, the metal or the metal of the metal oxide is selected from one or more of Ag, In, Au, Zn, Ti, Mn, Cu, Fe, Ni and Co. In embodiments of the invention where the nanoparticles are quantum dots (QDs), said QDs are selected from one or more of CdSe, CdS, CdTe, PbS, PbSe, ZnS, ZnSe, InP, InAs, CdHgTe, CdSe/CdS, CdSe/ZnS, CdSe/CdS/ZnS, CdTe/CdSe, CdTe/Cds, ZnSe/ZnS, CdTe/ZnS, InP/ZnS, InP/GaP/ZnS (e.g. cadmium free QDs, such as one or more of PbS, PbSe, ZnS, ZnSe, InP, InAs, ZnSe/ZnS, InP/ZnS, InP/GaP/ZnS, e.g. InP, InAs, InP/ZnS, InP/GaP/ZnS). In particular embodiments of the invention, the quantum dots are InP/ZnS.

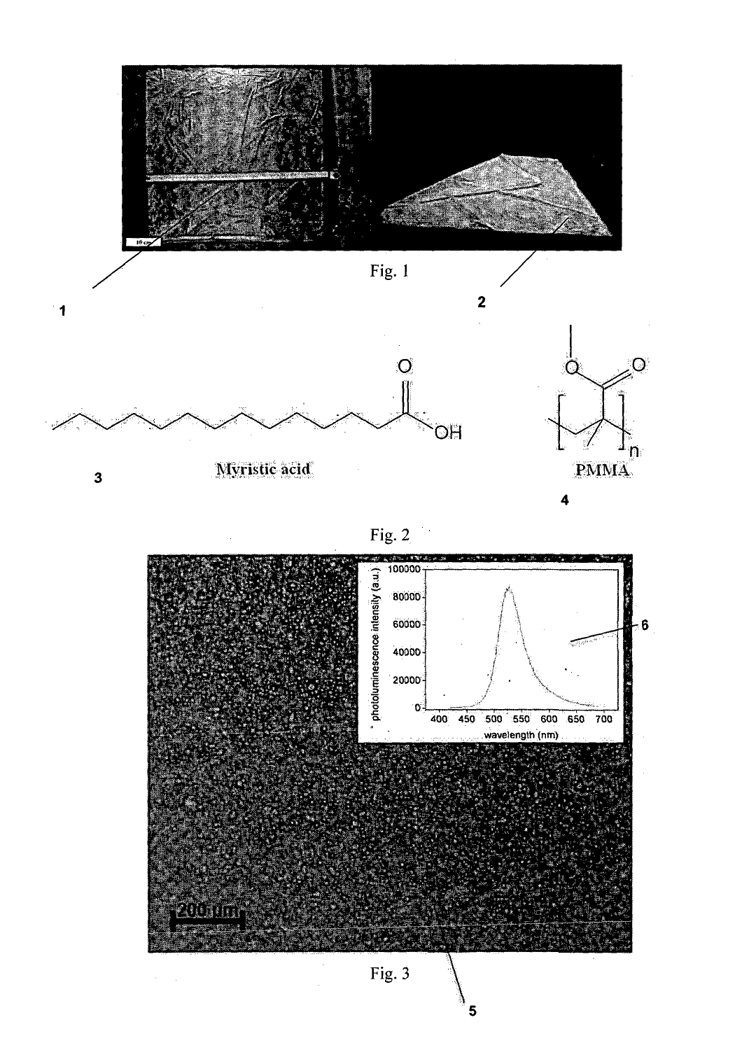

The nanoparticles (e.g. 5 of FIG. 3):

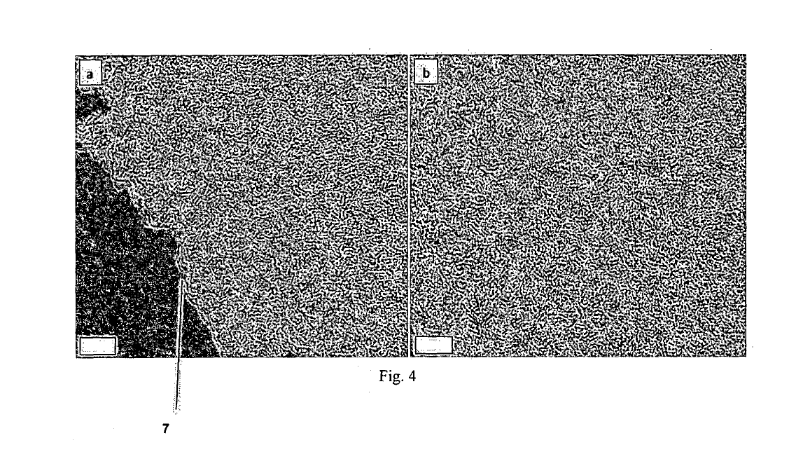

(a) are dispersed homogeneously throughout the polymer matrix, as shown in FIGS. 3 and 4;

(b) have a diameter of from 1 to 20 nm (e.g. from 2 to 10 nm).

In a particular example, the composite material comprising InP/ZnS quantum dots capped with a fatty acid ligand dispersed within a polymer matrix of polymethylmethacrylate, wherein the fatty acid ligand is Myristic acid (MA) and/or Stearic acid (SA).

The composite material may be used in light generation, light harvesting and light sensing and in matching optoelectronic devices. For example, the use can be large area ultra-violet light sensing where a large surface area is always required. Alternative embodiments include a device suitable for light generation, light harvesting and light sensing comprising the composite material disclosed herein. “Optoelectronic devices” refers to light engines, displays, photovoltaics and sensors.

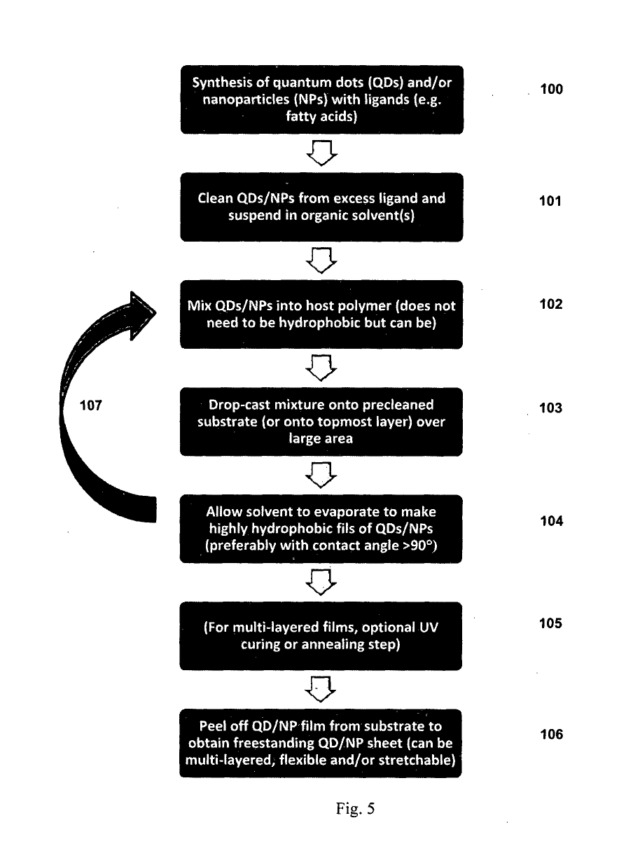

FIG. 5 shows a method of making a composite material as a film, comprising the steps of:

(a) mixing a polymer and a nanoparticle capped with a hydrophobic ligand together in at least one solvent 101;

(b) drop-casting the resulting mixture, or a portion thereof 103;

(c) allowing the solvent to evaporate to form the composite material as a film 104; and

(d) removing the film from the substrate in substantially one piece 106.

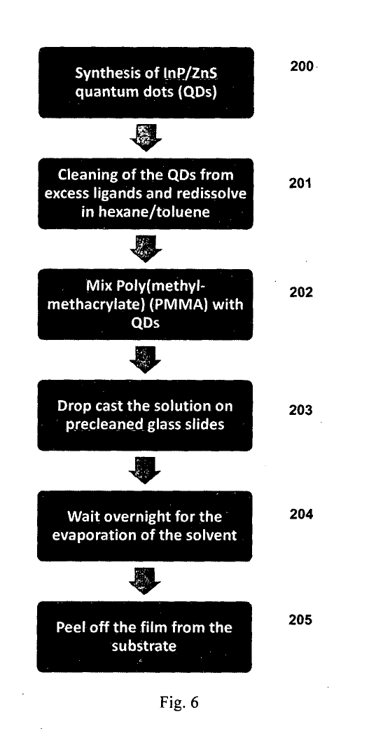

FIG. 6 shows the method applied to making the film of Example 1, using steps 200 to 205.

While an example embodiment involves the preparation of a film different shapes may also be fabricated using different shaped moulds. In fact if an appropriate mould is used, any shape of structure may in principle be fabricated.

The nanoparticles capped with a hydrophobic ligand can be synthesized using any known technique. For example, QDs may be synthesized by the methods set out by Reiss et al. J. Am. Chem. Soc. 2008, 130, 11588 or Nann et al. Adv. Mater. 2008, 20, 4068 or using modifications thereof.

In an embodiment the polymer is dissolved in a solvent (e.g. an aromatic or heterocyclic solvent, such as anisole) and the nanoparticles (e.g. quantum dots) capped with hydrophobic ligands are suspended in the same or a different solvent (e.g. one or more of an alkane solvent, an aromatic solvent or a heterocyclic solvent, such as toluene and/or hexane). It will be appreciated that the skilled person, knowing the physical and chemical properties of the polymer and the nanoparticles can choose an appropriate solvent, or solvents, for both materials. In general the initial colloidal suspension of the nanoparticles will have a concentration from 1 to 1000 μM, (e.g. from 10 to 120 μM, such as from 20 to 100 μM, or 30 to 70 μM).

In order to ensure that the nanoparticles are easily assimilated into the forming polymer matrix, the nanoparticles (e.g. QDs) are preferably cleaned with at least one solvent (e.g. one or more of isopropanol, acetone and methanol) to remove excess organic ligands (101 of FIG. 5).

Typically, the substrate is precleaned to remove any impurities from its surface and it is preferably placed on a smooth, uninclined plane to ensure that the resulting film is uniform in thickness and composition. The substrate can be any suitable substrate, for example a glass substrate. The mixture of polymer, nanoparticles and solvent is drop-cast onto the substrate at a pre-determined ratio. For example, the ratio may be from 0.2 mL per 10 cm² to 2 mL per 10 cm² (e.g. from 0.5 mL per 10 cm² to 1.5 mL per 10 cm², such as from 0.8 mL per 10 cm² to 1.2 mL per 10 cm², e.g. 1 mL per 10 cm²).

The substrate may be any material so long as it does not adsorbing the PMMA-QD solution and/or there should not be a chemical interaction (i.e., forming bonds) between the substrate and the solution.

The solution may be depositing using drop-casting or other solution processing methods. For example spin coating, ink-jet printing, dip coating, moulding, stamping, imprinting, doctor blading, air spraying, layer-by-layer assembly, Langmuir Blodgett coating, etc.).

In general, step (c) of the process (103 of FIG. 5) described above is performed over a period of from 4 hours to 24 hours (e.g. from 6 hours to 18 hours, such as from 8 hours to 12 hours).

In further embodiments of this aspect, as illustrated by FIG. 5, the film may be a multi-layered film, wherein one or more further layers are placed one on top of the other by steps set out below, said steps follow step (c) and precede step (d):

(i) mixing a polymer and a nanoparticle capped with a hydrophobic ligand together in at least one solvent, said polymer and nanoparticle capped with a hydrophobic ligand being the same or different to those previous used 102;

(ii) drop-casting the resulting mixture, or a portion thereof, onto the uppermost layer of film 103;

(iii) allowing the solvent to evaporate to form the composite material as a new layer of film 104; and

(iv) repeating until the required number of layers of film have been deposited 107.

When the film is a multilayered film, the film can be UV cured or annealed to further integrate the layers together before peeling the resulting multilayer film from the substrate 105 of FIG. 5.

As for a single film, the nanoparticles (e.g. QDs) to be used in each subsequent layer of a multilayer film are preferably cleaned with at least one solvent (e.g. one or more of isopropanol, acetone and methanol) to remove excess organic ligands before being used in the process described above (101 of FIG. 5).

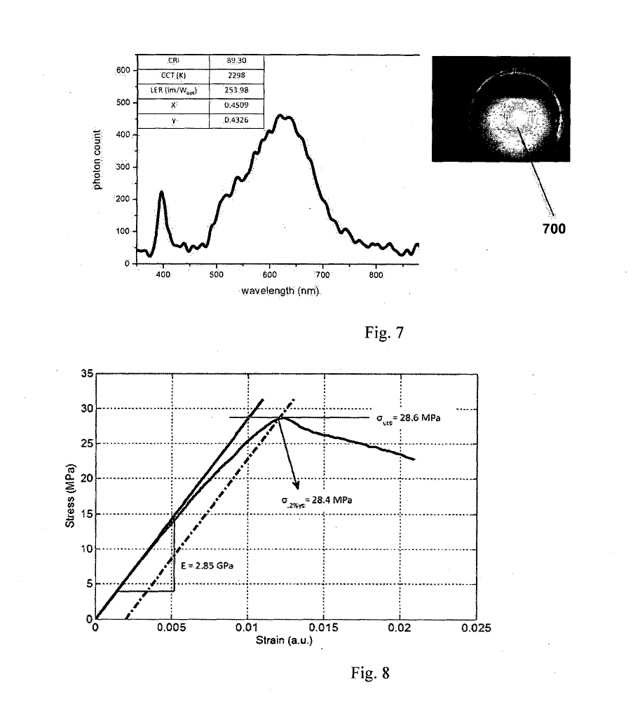

Using the above techniques, it is possible to obtain very large area, flexible films (e.g. see FIG. 8) using Cd-free quantum dot-polymer blends. For example, we disclose the use and demonstrate the manufacture of flexible, stand-alone, very large-area films 1, 2 (51 cm×51 cm) of InP/ZnS QDs which hold the promise for high-end device applications (e.g. see FIG. 1). Said films hold the potential for use in high-end device applications. To illustrate this point, the emission kinetics and nonradiative energy transfer of the films were studied and the films also showed high-quality white light generation by placing these films over a blue LED platform for remote phosphor applications (e.g. see FIG. 7). For example, when pumped by a blue LED, these Cd-free QD films allow for high color rendering, warm white light generation with a CRI of 89.30 and a CCT of 2,298 K.

For example, stand-alone films of InP/ZnS QD-polymer composites have been fabricated over very large areas of greater than a half meter by a half meter to enable high-end large-area optoelectronic applications. Demonstrated herein, is use of these InP/ZnS QD films as remote color-converting nanophosphors for white LED applications and therefore the use of such composite nanoparticle materials as a potential next-generation light generation technology platform. As a proof-of-concept demonstration of the stand-alone films, InP/ZnS QD films were placed over a blue LED platform for high-quality white light generation (see FIG. 7). Previously, Nann and coworkers (Adv. Mater. 2008, 20, 4068) used green-emitting phosphors along with red-emitting InP/ZnS quantum dots. As disclosed herein, a white LED (WLED), in which both the red and green color components are provided by the green- and red-emitting InP/ZnS QDs forming a film designed to result in high photometric quality. FIG. 7 shows the resulting emission spectra of the blue LED hybridized with the green-red emitting InP/ZnS quantum dot films and probed using a fiber coupled optical spectrum analyzer. The InGaN/GaN LED is driven at an electrical potential of 4.4 V. The white light generation using the excitation from the blue LED results in a color rendering index (CRI) of 89.30 with a correlated color temperature (CCT) of 2,298 K and a luminous efficacy of optical radiation (LER) of 253.98 lm/Wₒₚₜ and hence produces high color rendering, high spectral efficiency and warm white light. No changes in the spectra of the device under nonstop operation for >6 hours was observed, indicating that no thermal stability issue was present under operating conditions employed for the operation of the LED. These results demonstrate that these proof-of-concept WLED film based devices are promising candidates for remote phosphor applications, potentially for high-temperature light engines.

Experimental Section

Intermediate 1—Colloidal Synthesis of Donor InP/ZnS QDs

All reactions were performed under an inert Ar atmosphere using a Schlenk line or glove box unless otherwise indicated. For the synthesis of the green-emitting donor InP/ZnS QDs, the procedure by Reiss and coworkers was followed (J. Am. Chem. Soc. 2008, 130, 11588).

In a typical one pot synthesis, 0.1 mmol Indium Myristate (prepared by dissolving Indium Acetate in Myristic Acid with an In:Myristic Acid ratio of 1:4.3), 0.1 mmol Zinc Stearate, 0.1 mmol Dodecanethiol and 0.1mmol Tris(trimethylsilyl)Phosphine were dissolved in 8 mL Octadecene (ODE), mixed in a 3-necked 25 mL flask and evacuated at room temperature. The mixture was quickly heated to 300° C. under Ar or N₂ flow, and the growth of the QDs occurred within 20 min. Longer heating times resulted in a red-shift of the emission peak. The one pot synthesis uses MA as the capping agent.

Intermediate 2—Colloidal Synthesis of Acceptor InP/ZnS QDs

All reactions were performed under an inert Ar atmosphere using a Schlenk line or glove box. To obtain the orange/red-emitting acceptor QDs, a modified procedure proposed by the group of Nann was used (Adv. Mater. 2008, 20, 4068). For the core InP QDs, 0.1 mmol Indium Chloride, 0.1 mmol Stearic Acid, 0.08 mmol Zinc Undecylenate, and 0.2 mmol Hexadecylamine were dissolved in 3 mL ODE and heated to 240° C. under mixing in an inert atmosphere. At that temperature the phosphor precursor (0.5 mL Tris(trimethylsilyl)Phosphide dissolved in ODE, c=0.2 mmol/mL) was injected and cooled to room temperature after the core growth was established at 220° C. for 20 min. For the shell growth, 0.3 mmol Zinc Undecylenate was mixed with the as-prepared core QDs and evacuated well before heating. The solution was then heated up to 220° C. and 1 mL of Cyclohexyl Isothiocyanate/ODE solution (c=0.15 mmol/mL) was injected as the sulfur source followed by increasing the temperature to 240° C. and growth for 20 min, which resulted in orange/red emitting QDs. This synthesis uses SA and HDA as the ligand. MA is used for the synthesis of donor QDs. There are 2 different recipes used for the synthesis of InP/ZnS QDs.

Intermediate 3—TOPO and Oleic Acid Capped QD

In this case QDs were capped using TOPO and oleic acid. The QDs were CdSe based QDs. Typically there are more than one ligand within the structure of QDs. In this example we used QDs that have TOPO and oleic acid in their composition.

### EXAMPLE 1

### Fabrication of Large-Area Freestanding Films Using Intermediate I

As-synthesized InP/ZnS QDs were cleaned using isopropanol, acetone and methanol extraction to remove the excess organic ligands and the precipitated particles were dissolved in fresh hexane/toluene. The following discussion of the membrane formation is based on the QDs that are further used as the donor QDs in the other experiment.

Typically, 5 mL of PMMA A15 (MicroChem) is diluted with 5 mL of anisole and mixed with 4 mL of QDs in toluene with a concentration of ca. 60 μM. The solution is stirred rigorously for 30 min, and the solution cleared from any air bubbles. Subsequently, 5 mL of this solution is drop-cast on a pre-cleaned glass substrate with a ratio of 1 mL per 10 cm² of film.

The area size of the substrate is where the dispersion is drop-casted. The dispersion needed for 10 cm² film can be scaled up/down depending on the size of the desired film thickness. This example ratio provides 65 μm thick film. However, depending on the desired film thickness, the PMMA ratio in the film may be selected accordingly. Higher PMMA concentration would give thicker films. We do not need to relate it with large-area demonstration. The ratio (PMMA:QD) would change the thickness of the film, not the size.

The glass substrate is placed on a smooth, uninclined plane to avoid nonuniformity of the film, and left for drying under controlled evaporation without the need for heating the substrate. Upon drying, the film is peeled off from the glass substrate, the thickness of the film prepared in this way being 65 μm.

It is possible to tune the QD loading and thickness of the formed films by changing the ratio of the PMMA to anisole and the amount of QDs within the solution. The ease of peeling of the film was made possible because of the interaction of the ligand of the QDs, the myristic acid, with PMMA, thus providing a hydrophobic layer on the glass substrate which is readily peeled off.

### EXAMPLE 2

### Fabrication of Multilayered Freestanding Films Using Intermediates 1 and 2

The multi-layered film discussed below, is for the demonstration of white light by using different combinations of QD emissions. The first layer was formed (green QDs) and dried completely, and then the second layer (red QDs) was applied on top of the first. After complete evaporation, the multi-layered film was peeled off.

The donor-acceptor film was produced by mixing them together to form a blended film structure. It is the film used for the energy transfer experiments.

### COMPARATIVE EXAMPLE 1

Using a similar process to Example 1 above, intermediate 3 was drop cast with PMMA to form a composite nanoparticle film onto a glass substrate. It was found that it was not possible to easily peel this film off the glass substrate, meaning that it is not suitable for use in the formation of uniform large-are free standing films. A small-area demonstration of the film was used to compare the free standing membrane formation. TOPO and oleic acid are used within the structure of the same QDs.

### COMPARATIVE EXAMPLE 2

PMMA alone in anisole was drop cast onto a glass substrate, which solvent was allowed to evaporate in controlled conditions to leave a film of PMMA on the substrate. It was found that it was not possible to easily peel this film off the glass substrate, meaning that the QDs of Examples 1 and 2 are partly responsible for the easy peel effect necessary for large-area free standing films.

Characterization of QDs

A Cary 100 UV-VIS, Cary Eclipse fluorescence spectrophotometer and Horiba Yvon Fluorolog were used for the optical characterizations of the QDs. The time resolved fluorescence measurements were acquired with a Pico Quant Fluo Time 200 set-up, TEM images were taken employing a FEI Tecnai G2 F30 and X-ray photoelectron spectroscopy (XPS) measurements using K-Alpha-Thermo. The mechanical characterizations were carried out with Instron 5969 MTS, the thermogravimetric analysis (TGA) was performed with a TGA Q500 (TA Instruments), the fluorescence microscopy images were taken using a Carl Zeiss Axio Scope upright microscope, and the contact angle measurements, with a Dataphysics, OCA 15-EC.

Contact Angle Measurements

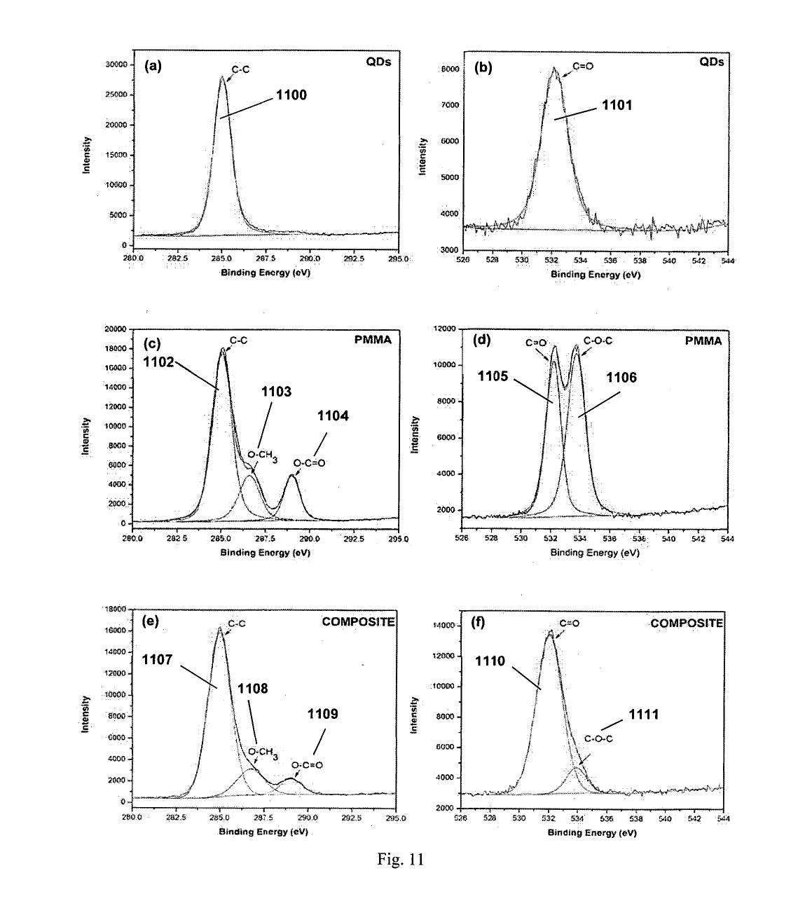

As illustrated in FIG. 10, contact-angle measurements of the freestanding InP/ZnS QD film 400 of Example 1, which has a contact angle of ˜90°, shows an enhanced hydrophobicity, over that of the PMMA only film 402 which has a nominal contact angle of ˜80°.

The contact angle being measured by the water droplet 401, 403 deposited on the InP/ZnS QD film 400 and PMMA only film 402, respectively. This is the green-emitting QDs with PMMA, for the film prepared for small-area demonstration (EX1 in small area demonstration).

Preparation of Microtome Slides for TEM Analysis and TEM Analysis

For the microtome cutting of cross-sections of a InP/ZnS-PMMA film for the purpose of TEM analysis, a small amount of the film is put in the holder (capsules with a 5.6 mm O.D. and a pyramid tip, made from polyethylene) in which HistoResin (hardener) and Technovit 7100 were mixed in the ratio 1:15, respectively. The mixture is placed to one side for ˜2 h to become solid. A Leica EM UC6/EM FC6 Ultramicrotome operated at −100° C. is used to slice the sample in thicknesses of up to ˜100 nm. Transmission electron microscopy (TEM) images of ultrathin (˜100 nm) sections of these films were recorded by FEI-Tecnai G2 F30 electron microscope operating at 300 kV.

The TEM images taken at various positions of the sample demonstrate the uniformity of the QDs dispersed within the host PMMA (see FIG. 4).

Fluorescence Microscopy of the QD-PMMA Composite Film:

The InP/ZnS QD-PMMA film of EX1 in small area demonstration was investigated using a Carl Zeiss Axio Scope upright microscope with UV excitation and equipped with a green filter. FIG. 3 shows the fluorescence microscopy image 5. From this figure, the film homogeneity may be observed across a large area of the sample. The emission spectrum 6 of the film (with its emission peak at 527 nm) is also given in the inset of FIG. 3.

Absorption Profile of the QD-PMMA Composite Film:

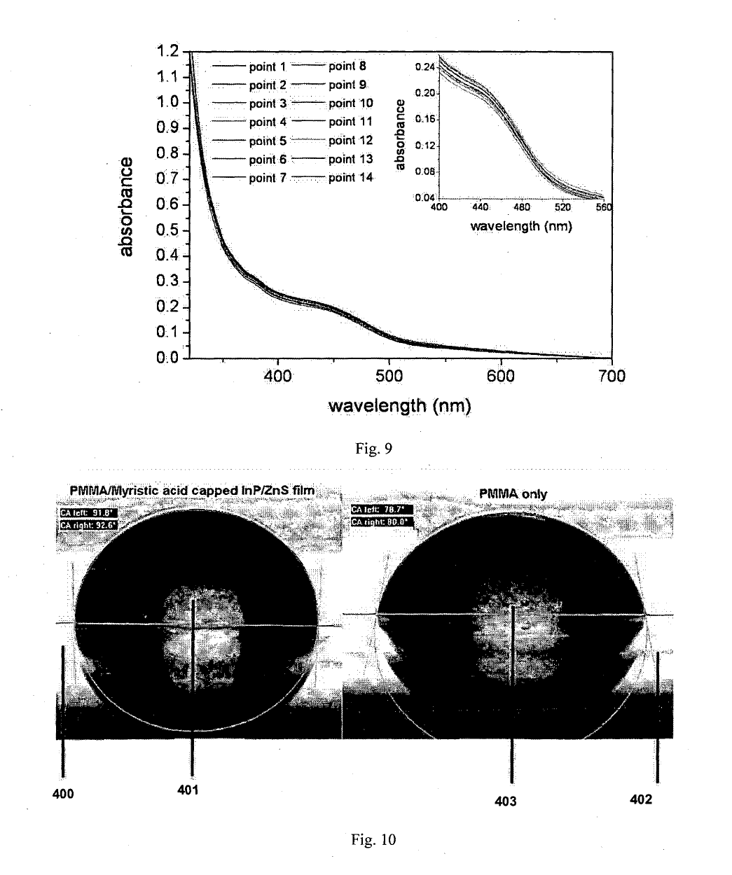

In order to verify the homogeneity of the films produced, the optical absorption of the sample at different positions of the film of EX1 in small area demonstration was measured. As shown in FIG. 9, >90% of the incident light in the UV is absorbed by the quantum dot loaded films. At the excitonic peak of the quantum dots, the absorbance values differ only between a minimum value of 0.1931 and a maximum of 0.2147, corresponding to <10% difference in the absorbance of the film.

Mechanical Characterization of the QD Composite Film:

To investigate the mechanical properties of the QD film, a stress-strain characterization was performed by applying a load to the film. This test used a 35 μm thick film monolayer; the ultimate tensile strength, sᵤₜₛ, for the 35 μm thick film was found to be 28.6 MPa, while the offset yield strength at 0.2%, S_{0.2% ys}, is 28.4 MPa and the Young's modulus (E) is 2.85 GPa, which is in the range of the reported Young's Modulus value for pure PMMA (see FIG. 8). This demonstrates that the composite materials of the current invention are able to maintain the physical properties of the polymer (in this case the mechanical flexibility of the polymer), while adding additional properties to the composite, as will be demonstrated in further detail below.

Proof of Concept for Use in LED Applications

Finally, as a proof-of-concept demonstration of the stand-alone films, InP/ZnS QD films were placed over a blue LED platform for high-quality white light generation. Previously, Nann and coworkers (Adv. Mater. 2008, 20, 4068) used green-emitting phosphors along with red-emitting InP/ZnS quantum dots. A white LED (WLED), in which both the red and green color components are provided by the green- and red-emitting InP/ZnS QDs forming a bilayer film of Example 2, as shown in the inset 700 of FIG. 7, designed to result in high photometric quality. FIG. 7 shows the resulting emission spectra of the blue LED hybridized with the green-red emitting InP/ZnS quantum dot films and probed using a fiber coupled optical spectrum analyzer. The InGaN/GaN LED is driven at an electrical potential of 4.4 V. The white light generation using the excitation from the blue LED results in a color rendering index (CRI) of 89.30 with a correlated color temperature (CCT) of 2,298 K and a luminous efficacy of optical radiation (LER) of 253.98 lm/Wₒₚₜ and hence produces high color rendering, high spectral efficiency and warm white light. We have not observed any changes in the spectra of the device under nonstop operation for >6 hours indicating that no thermal stability issue was present under the operating conditions employed for the operation of the LED. These results demonstrate that these proof-of-concept WLED freestanding films are promising candidates for remote phosphor applications, potentially for high-temperature light engines.

Elemental Composition of QD Composite Films

To characterize the elemental composition of the QD composite film, X-ray photoelectron spectroscopy (XPS) experiments were done. The high-resolution Carbon 1s and Oxygen 1s spectra are shown for the PMMA polymer, InP/ZnS QDs and the QD-PMMA composite in FIG. 11. For PMMA, the C 1s spectra are resolved into three components with different bonding states: C—C (1102) at 285.0 eV, O—CH₃ (1103) at 286.5 eV and O—C═O (1104) at 288.9 eV. O 1s spectra of the PMMA polymer consist of two components: C═O (1105) at 532.1 eV and C—O—C (1106) at 533.6 eV. The atomic percentage of the peaks are C—C (51.49%; 1102), O—CH₃ (15.12%; 1103), O—C═O (11.18%; 1104), C═O (9.79%; 1105), and C—O—C (12.42%;), the distribution of which is common for standard XPS spectra of the PMMA (Surf Sci. Spectra 2008, 2, 71). High Resolution C 1s and O 1s spectra of QDs (due to ligands) show single peaks at 285.0 eV (1110) and 532.1 eV (1101), respectively. The C 1s spectra of the composite PMMA-QD film are also resolved into three components and the O 1s spectra into two components, similar to pure PMMA. Here we observe modifications in the atomic percentages of the peaks in the composite verifying the incorporation of QDs in the composite. The atomic percentage of the peaks are C—C (58.58%; 1107), O—CH₃ (11.03%; 1108), O—C═O (5.26%; 1109), C═O (22.29%; 1110), and C—O—C (2.84%; 1111). We also observe a large decrease in the intensity of the C 1s peak of the pure QDs in the composite, which also suggests a change in the microenvironment of the QDs in the composite. This is further confirmed by the shift in the QD elemental peaks at 0.3 eV in the composites compared to the pure QDs. The XPS results therefore support the notion that the QDs and PMMA form a composite structure.

Emission Kinetics of Donor/Acceptor

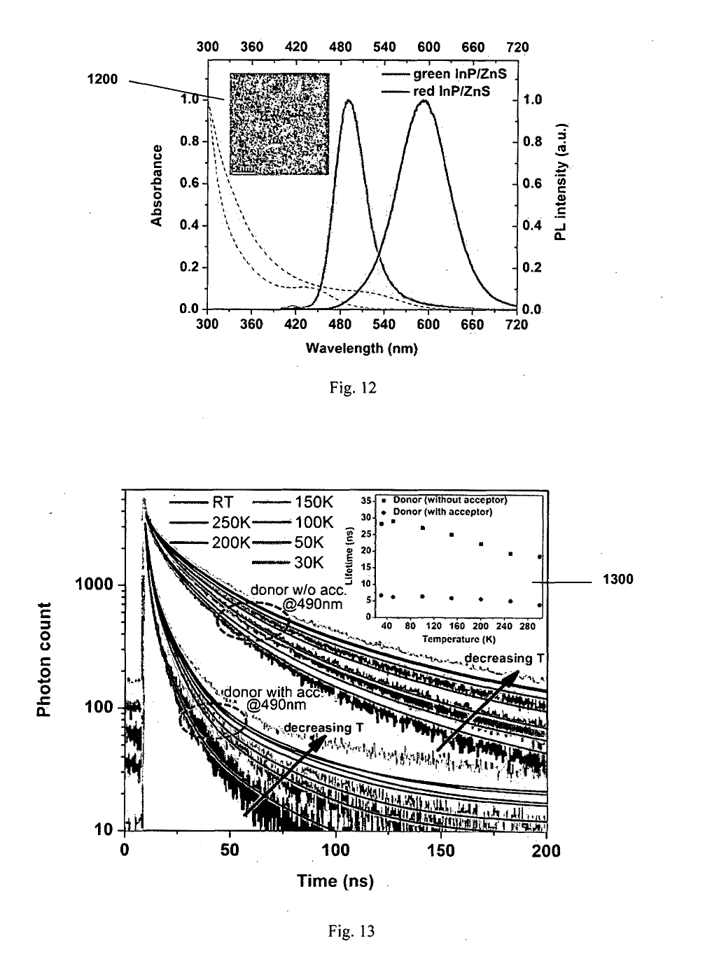

To investigate the emission kinetics of the InP/ZnS QD films, we have studied Förster-type nonradiative energy transfer (FRET) within the film. The use of QDs as energy transfer agents for FRET-based applications has been previously studied extensively for other material systems with the view to developing new platforms for light generation and harvesting (Mutlugun, E. et al. Opt. Exp. 2010, 18, 10720; Medintz, I. L. et.al. Phys. Chem.Chem. Phys. 2009, 11, 17; Boeneman, K. et al. J. Am. Chem. Soc. 2009, 131, 3828; Freeman, R. et.al. Nano Lett. 2010, 10, 2192.)). Although, such FRET-based systems have also been widely used in conjunction with dyes, proteins, and other nanostructured materials including quantum wells, quantum wires and quantum dots, (Clapp, A. R. et.al. Chem. Phys. Chem. 2006, 7, 47; Higgins, C. et.al. Opt. Express 2010, 18, 24486; Franzl, T. et.al. Appl. Phys. Lett. 2004, 84, 2904; Clapp, A. R. et.al. J. Am. Chem. Soc. 2004, 301; Lee, J. et.al. Nano Lett. 2005, 5, 2063; Willard, D. M. et.al. Nano Lett. 2001, 1, 581; Medintz, I. L. et.al. Nat. Mat. 2003, 2, 630; Wargnier, R. et.al. Nano Lett. 2004, 4, 451.), FRET based systems of QD-polymer composites for such free standing forms have not been studied to date, which would introduce a new channel from the light generation and harvesting application point of view. In particular, our previous study demonstrated a possibility of efficient tuning of color coordinates of QDs/polymer composites via controllable FRET (Appl. Phys. Lett. 2009, 94, 061105). FIG. 12 shows the emission and absorption spectra of green-emitting (donor) and red-emitting (acceptor) InP/ZnS QDs in solution together with their transmission electron microscopy (TEM) image 1200 in the inset. The diameter of these donor and acceptor QDs are observed from the TEM images to be ˜2.4 and 2.8 nm, respectively. The acceptor QDs have been chosen to emit around 100 nm further to the red of the donor emission peak to prevent the emission overlap to a good extent and study their emission kinetics and the energy transfer between them.

The effect of the acceptor on the donor emission kinetics was studied by comparing the time resolved photoluminescence (TRPL) decay profile of the bare donor QD containing film with the donor-acceptor QD film (with both samples having the same donor concentration) (see FIG. 13). In the film, the peak emission wavelengths of the donor and acceptor QDs are 490 and 590 nm, respectively and are therefore spectrally well separated from each other (see also FIG. 6), making the time-resolved analysis viable. The temperature dependence of the time-resolved fluorescence for each species of interest was also investigated and the decay curves were fit using a tri-exponential fitting function. The requirement for the use of tri-exponential functions for the fitting is due to the nontrivial emission kinetics of the InP/ZnS quantum dots. In various QD samples the monoexponential decay originates mainly from radiative decay channels and one would expect this type of decay from high-quality QDs, i.e., QDs which are mostly free of defects and surface trap states. In other words, the main contribution to the emission decay is the radiative recombination rate. On the other hand, a multi-exponential decay stems from the presence of non-radiative channels that are associated with energy transfer, Auger recombination/relaxation processes and possibly defects and surface traps. Thus, the main contribution to the emission decay is from the non-radiative recombination rates. In such cases, the amplitude weighted average lifetime gives a good estimate for the exciton lifetime, as has been suggested for the FRET mediated lifetime modifications (Principles of fluorescence spectroscopy; Springer: New York, 2006). The fitting parameters for the amplitude weighted lifetime for the donor and acceptor before and after FRET is given in Tables I to IV below.

TABLE I
Fitting parameters for the donor lifetime before FRET.
Donor lifetime before FRET

| Temper- | | | | | | | | |
|---|---|---|---|---|---|---|---|---|
| ature | | | | | | | tₐᵥₑ_{_{—}}_{amp. weighted} | tₐᵥₑ_{_{—}}_{int. weighted} |
| (° C.) | A₁ | t₁ (ns) | A₂ | t₂ (ns) | A₃ | t₃ (ns) | (ns) | (ns) |
| 300 | 562.86 ± 9.69 | 57.585 ± 0.742 | 1258.7 ± 91.7 | 3.494 ± 0.308 | 1940.4 ± 31.6 | 16.794 ± 0.253 | 35.00 | 18.45 |
| 250 | 667.60 ± 10.40 | 55.932 ± 0.690 | 1225.8 ± 92.7 | 3.396 ± 0.314 | 1902.4 ± 31.9 | 16.725 ± 0.266 | 35.94 | 19.32 |
| 200 | 732.80 ± 10.60 | 61.169 ± 0.722 | 1105.4 ± 87.7 | 3.980 ± 0.387 | 2053.1 ± 32.0 | 18.237 ± 0.270 | 39.72 | 22.27 |
| 150 | 874.00 ± 11.30 | 62.143 ± 0.654 | 928.0 ± 92.6 | 3.664 ± 0.457 | 1945.2 ± 32.8 | 18.436 ± 0.308 | 43.27 | 24.99 |
| 100 | 1006.50 ± 11.80 | 63.022 ± 0.644 | 859.0 ± 96.6 | 3.370 ± 0.482 | 1902.0 ± 33.1 | 18.593 ± 0.325 | 45.87 | 26.99 |
| 50 | 1009.90 ± 11.70 | 66.755 ± 0.682 | 845.8 ± 89.9 | 3.841 ± 0.517 | 1867.2 ± 31.8 | 20.049 ± 0.343 | 48.69 | 29.04 |
| 30 | 1116.40 ± 12.3 | 63.801 ± 0.615 | 873.0 ± 102.0 | 3.142 ± 0.742 | 1904.3 ± 33.6 | 18.940 ± 0.340 | 47.59 | 28.26 |

TABLE II
Fitting parameters for the donor lifetime after FRET.
Donor lifetime after FRET

| Temper- | | | | | | | | |
|---|---|---|---|---|---|---|---|---|
| ature | | | | | | | tₐᵥₑ_{_{—}}_{amp. weighted} | tₐᵥₑ_{_{—}}_{int. weighted} |
| (° C.) | A₁ | t₁ (ns) | A₂ | t₂ (ns) | A₃ | t₃ (ns) | (ns) | (ns) |
| 300 | 88.10 ± 5.55 | 30.41 ± 1.41 | 1733.0 ± 106.0 | 1.3696 ± 0.090 | 704.9 ± 28.8 | 6.767 ± 0.226 | 11.91 | 3.89 |
| 250 | 137.81 ± 7.01 | 32.35 ± 1.19 | 1977.0 ± 110.0 | 1.776 ± 0.107 | 1069.3 ± 35.5 | 7.336 ± 0.198 | 13.15 | 4.97 |
| 200 | 138.69 ± 6.79 | 35.10 ± 1.25 | 1896.1 ± 99.7 | 2.030 ± 0.115 | 1004.2 ± 32.9 | 8.122 ± 0.217 | 14.52 | 5.55 |
| 150 | 135.31 ± 6.30 | 39.86 ± 1.42 | 1977.6 ± 98.3 | 2.093 ± 0.112 | 1016.9 ± 31.6 | 8.647 ± 0.221 | 16.35 | 5.85 |
| 100 | 141.73 ± 6.55 | 40.59 ± 1.51 | 1747.0 ± 96.2 | 2.087 ± 0.126 | 997.8 ± 31.0 | 8.882 ± 0.232 | 17.52 | 6.33 |
| 50 | 156.39 ± 6.75 | 40.62 ± 1.37 | 1944.0 ± 110.0 | 1.866 ± 0.116 | 1081.6 ± 32.7 | 8.848 ± 0.228 | 17.87 | 6.14 |
| 30 | 166.01 ± 7.05 | 39.65 ± 1.32 | 1600.0 ± 104.0 | 1.880 ± 0.137 | 1069.2 ± 32.9 | 8.626 ± 0.229 | 18.4 | 6.63 |

TABLE III
Fitting parameters for the acceptor lifetime before FRET.
Acceptor lifetime before FRET

| Temper- | | | | | | | | |
|---|---|---|---|---|---|---|---|---|
| ature | | | | | | | tₐᵥₑ_{_{—}}_{amp. weighted} | tₐᵥₑ_{_{—}}_{int. weighted} |
| (° C.) | A₁ | t₁ (ns) | A₂ | t₂ (ns) | A₃ | t₃ (ns) | (ns) | (ns) |
| 300 | 247.59 ± 8.14 | 48.690 ± 1.26 | 1897.2 ± 84.1 | 3.440 ± 0.170 | 1404.0 ± 30.0 | 13.380 ± 0.246 | 23.04 | 10.53 |
| 250 | 320.36 ± 8.40 | 47.689 ± 0.916 | 1962.7 ± 90.4 | 3.370 ± 0.174 | 1601.4 ± 32.4 | 13.171 ± 0.230 | 23.93 | 11.07 |
| 200 | 359.40 ± 8.54 | 51.267 ± 0.905 | 1574.3 ± 82.7 | 3.746 ± 0.225 | 1565.5 ± 31.2 | 14.258 ± 0.251 | 27.55 | 13.33 |
| 150 | 434.97 ± 9.10 | 53.631 ± 0.852 | 1525.4 ± 85.5 | 3.766 ± 0.245 | 1718.4 ± 31.9 | 15.067 ± 0.252 | 30.25 | 14.94 |
| 100 | 558.04 ± 9.97 | 54.022 ± 0.749 | 1411.9 ± 84.1 | 3.981 ± 0.280 | 1791.3 ± 32.5 | 15.612 ± 0.260 | 32.76 | 16.95 |
| 50 | 624.20 ± 10.20 | 57.277 ± 0.747 | 1146.6 ± 85.1 | 3.853 ± 0.345 | 1788.2 ± 32.2 | 16.263 ± 0.279 | 36.65 | 19.46 |
| 30 | 664.50 ± 10.60 | 54.955 ± 0.729 | 1137.8 ± 85.6 | 3.781 ± 0.344 | 1784.1 ± 32.3 | 16.188 ± 0.277 | 35.73 | 19.44 |

TABLE IV
Fitting parameters for the acceptor lifetime after FRET.
Acceptor lifetime after FRET

| Temper- | | | | | | | | |
|---|---|---|---|---|---|---|---|---|
| ature | | | | | | | tₐᵥₑ_{_{—}}_{amp. weighted} | tₐᵥₑ_{_{—}}_{int. weighted} |
| (° C.) | A₁ | t₁ (ns) | A₂ | t₂ (ns) | A₃ | t₃ (ns) | (ns) | (ns) |
| 300 | 463.22 ± 9.08 | 56.594 ± 0.814 | 1506.2 ± 84.5 | 4.060 ± 0.267 | 1837.6 ± 31.0 | 16.718 ± 0.252 | 32.07 | 16.56 |
| 250 | 550.68 ± 9.77 | 56.475 ± 0.756 | 1452.6 ± 87.9 | 3.947 ± 0.283 | 1937.8 ± 32.0 | 16.828 ± 0.252 | 33.52 | 17.62 |
| 200 | 585.11 ± 9.67 | 60.902 ± 0.771 | 1337.8 ± 83.1 | 4.291 ± 0.318 | 1935.3 ± 30.6 | 18.328 ± 0.265 | 37.02 | 19.92 |
| 150 | 756.20 ± 10.80 | 60.609 ± 0.691 | 1013.0 ± 84.6 | 4.197 ± 0.430 | 1977.4 ± 31.7 | 18.519 ± 0.284 | 40.07 | 23.14 |
| 100 | 861.10 ± 11.00 | 62.919 ± 0.682 | 858.6 ± 89.4 | 3.727 ± 0.487 | 1982.1 ± 31.4 | 19.098 ± 0.298 | 43.51 | 25.73 |
| 50 | 859.00 ± 10.70 | 70.717 ± 0.789 | 771.2 ± 88.0 | 3.880 ± 0.559 | 1930.1 ± 30.2 | 21.074 ± 0.327 | 49.46 | 29.33 |
| 30 | 885.20 ± 10.80 | 69.585 ± 0.782 | 740.4 ± 93.9 | 3.419 ± 0.555 | 1895.5 ± 30.4 | 20.762 ± 0.338 | 49.40 | 29.39 |

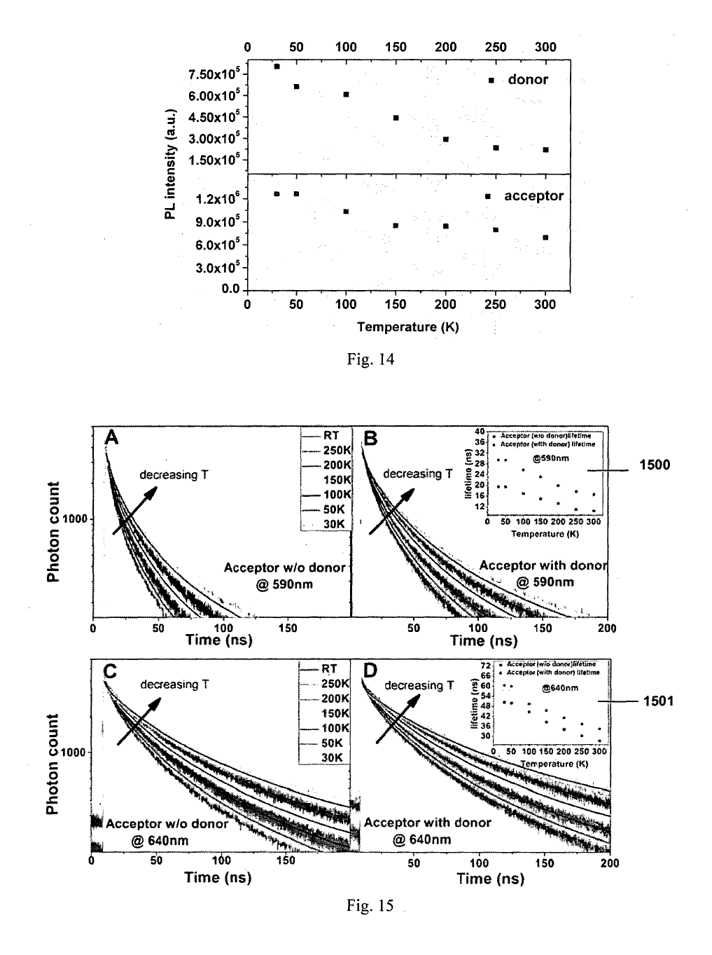

The amplitude-weighted lifetime values, for the donor only films, range from 18.45 to 28.26 ns as the sample temperature is decreased from 300 to 30 K. As the donor only sample was cooled from room temperature to cryogenic temperatures (30 K), the photoluminescence decay curves were observed to possess a gentler slope, i.e., the lifetime increased, which implies the inhibition of nonradiative recombination channels, due to the suppression of the phonon vibrations at cryogenic temperatures. The in-film PL intensity of the film donor and acceptor QDs as a function of temperature is also provided (e.g. see FIG. 14). In addition, the emission kinetics of the donor only film sample have been compared with the donor-acceptor hybrid film and it was observed that a significant decrease in the lifetime of the donor QDs when in the presence of acceptors. In other words, the donor lifetime shortens as the donor transfers its excitation energy to an acceptor present in close proximity in the film. Another conclusion derived from the temperature dependent lifetime measurements of the hybrid film is that, as the films are cooled to cryogenic temperatures, the nonradiative recombination channels are suppressed due to the suppression of the phononic vibrations. Therefore, the lifetime becomes longer as in the case of the donor only film These results are shown in FIG. 15 together with the temperature dependent lifetimes of the bare donor and hybrid film samples as insets 1500 and 1501 and are summarized in Table V.

TABLE V
Experimental and theoretical changes in the lifetime of the donor alone and in the
hybrid film of the donor with the acceptor, along with the experimental and theoretical
FRET efficiencies.
Analysis of the changes in the lifetime of the donor

| | | | Theoretical Donor | | |
|---|---|---|---|---|---|
| | | Experimental Donor | lifetime when in | | Theoretical |
| | Experimental | lifetime when in | donor + acceptor | | FRET |
| | donor lifetime | donor + acceptor | hybrid film | Experimental | efficiency |
| Temp | when alone | hybrid film | (including T | FRET | (including T |
| (K.) | (@490 nm) (ns) | (@490 nm) (ns) | dependence) (ns) | efficiency | dependence) |
| 300 | 18.45 | 3.89 | 3.83 | 0.789 | 0.793 |
| 250 | 19.32 | 4.97 | 4.26 | 0.742 | 0.779 |
| 200 | 22.27 | 5.55 | 4.70 | 0.751 | 0.789 |
| 150 | 24.99 | 5.85 | 5.14 | 0.766 | 0.794 |
| 100 | 26.99 | 6.33 | 5.57 | 0.765 | 0.793 |
| 50 | 29.04 | 6.14 | 6.01 | 0.789 | 0.793 |
| 30 | 28.26 | 6.63 | 6.18 | 0.765 | 0.781 |

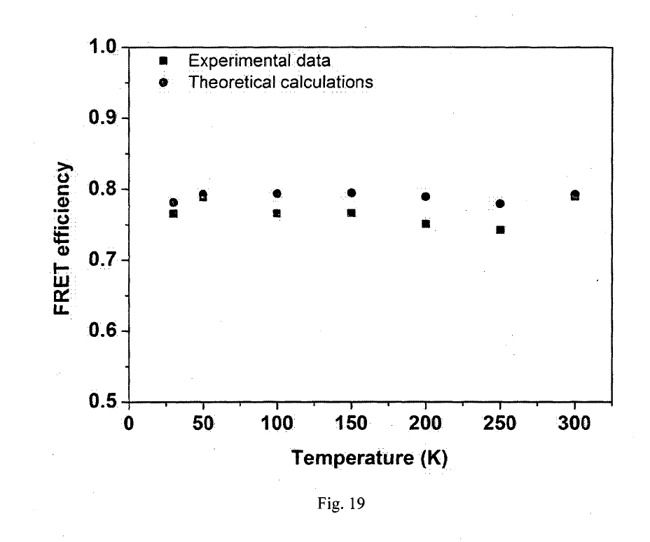

Using the modification of the donor lifetimes, the corresponding FRET efficiencies were calculated using

$$η = 1 - \frac{{τ}_{DA}}{{τ}_{D}} \qquad ( 1 )$$

where τ_{DA} is the lifetime of the donor in the presence of the acceptor and τ_{D} is the lifetime of the donor alone. We observe ˜80% energy transfer efficiency (see FIG. 19, and Table V), which is in good agreement with our theoretical model based on exciton-exciton interaction (full details of the theoretical approach are given below).

In our theoretical approach, which is derived from the simplest rate model, the donor lifetime in the presence of the acceptor is given by

$${τ}_{DA}^{D} = \frac{{τ}_{exc}^{D}}{1 + {( \frac{{R}_{0}}{r} )}^{6}} \qquad ( 2 )$$

where τ_{DA}^{D} is the donor exciton lifetime in the case of energy transfer. The energy transfer rate (γₜᵣₐₙₛ) between the donor-acceptor (D-A) QD pair is then obtained by

$${γ}_{trans} = \frac{1}{{τ}_{D}} {( \frac{{R}_{0}}{r} )}^{6} \qquad ( 3 )$$

where R₀ is the Förster radius for the D-A pair and r is the separation distance for the D-A QD pair (Lakowicz, J. R. Principles of fluorescence spectroscopy; Springer: New York, 2006). Table SI presents the experimentally measured and theoretically calculated lifetimes for the donor and acceptor pair when the measurements are analyzed at both the donor and acceptor emission wavelengths. Here the average separation distance (r) between the D-A pair is ˜3.63 nm. In the theoretical analysis, we consider the temperature dependence using a semi-empirical approach by calculating the change in the lifetime of the donor/acceptor species as a function of temperature (see inset 1300 FIG. 13). This is a valid approximation since the experimentally observed FRET efficiencies do not change significantly with changing temperature. To determine the number of quantum dots within the film, the TEM size of the donor and acceptor quantum dots, as well as the extinction coefficients were used. The total number of particles is calculated to be 5.05×10¹⁵. Since the volume per unit particle is 2.77×10⁻²⁵ m³, in the film, the particle to particle distance is found to be approximately 4.0 nm, which is less than the Förster radius and is also comparable to theoretically expected value of 3.63 nm. Also, the microtome TEM image of the film with a similar quantum dot loading shows the interparticle distance to be within the same distance range of <5 nm.

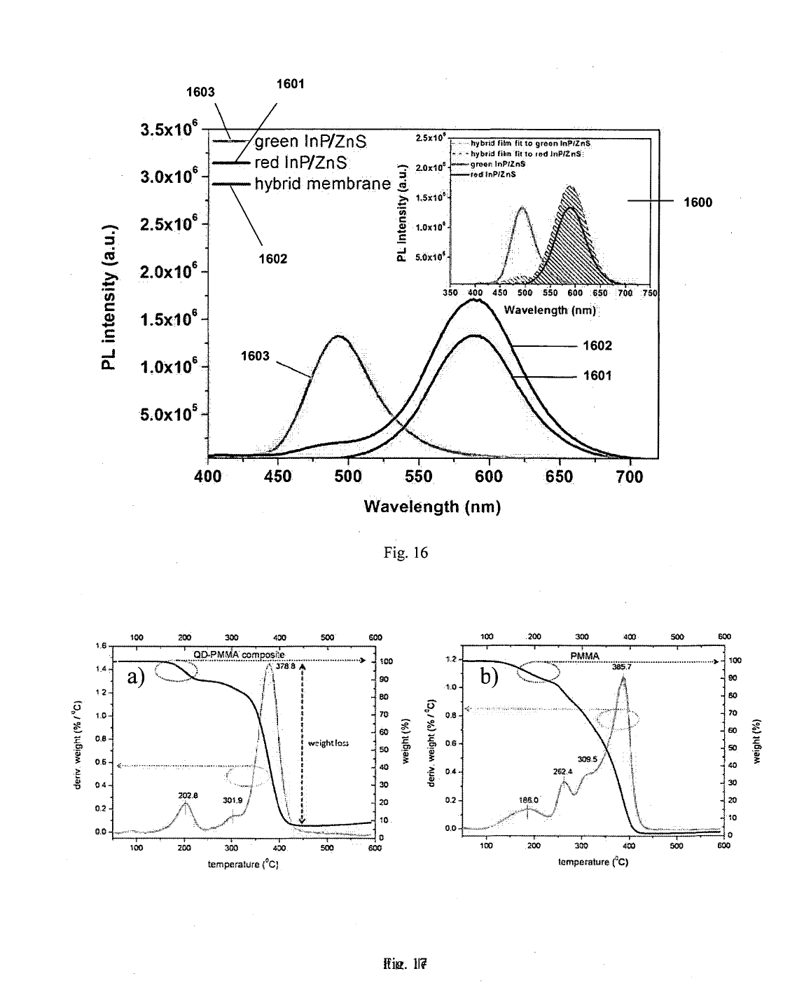

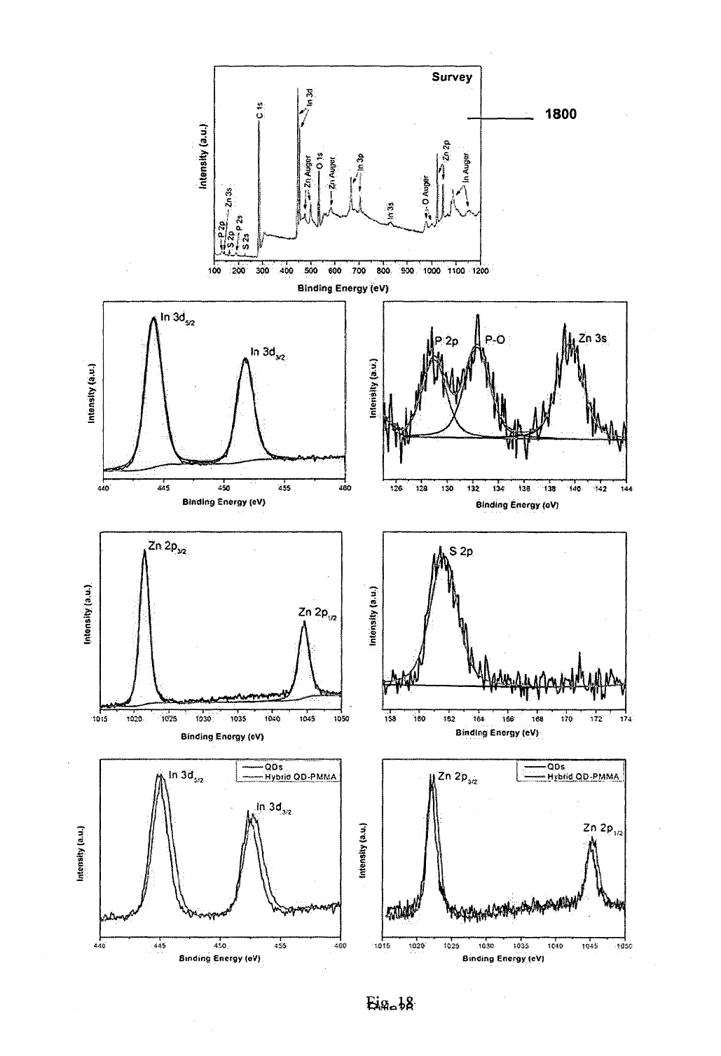

FIG. 16 shows the photoluminescence spectra of the donor only 1603 and acceptor only 1601 films, together with the hybrid donor-acceptor film 1602 at room temperature, all under the same conditions. Here, as a result of FRET, the donor emission is suppressed by ˜80% whereas the overall acceptor emission is increased by ˜30%, which is obtained from the hybrid emission spectra (fit to the donor-acceptor emission in a Gaussian profile, as shown in the inset 1600 of FIG. 16). We have also compared the results of the time-resolved measurements with the room temperature steady-state measurements. The modification of the steady-state photoluminescence of the donor and acceptor matches well that of the room temperature time-resolved lifetime modifications (79% for the donor and 57% for the acceptor). This implies that the excitons transferred from the donor are mostly contributed to the nearby acceptors.

Thermal Gravimetric Analysis (TGA) of the PMMA and QD Loaded PMMA Films:

Thermal gravimetric analysis (TGA) of the PMMA film with and without quantum dots was also undertaken. For comparison of the PMMA only film to the PMMA+QD composite film with monolayer structure, small area demonstration of EX1, the TGA results show that ca. 4% of the mass of the film is composed of the inorganic QDs, as shown in FIG. 17. Furthermore, the derivative of the mass change with respect to the temperature provided extra information about the specific temperature points where the mass change occurs. The observed shift of the peak values of the differential mass change of the PMMA only occurs after loading the PMMA with QDs.

XPS Measurement of the QD-PMMA Composite Film:

A typical XPS survey spectrum 1800 for the QD-PMMA composite small area demonstration of EX1 is shown in FIG. 18. The survey scan indicates the presence of In, P, Zn, S from the InP/ZnS quantum dots as well as C and O from the PMMA polymer. A high resolution XPS spectrum for all elements is also given. The In core is orbit split to 3d_{5/2} and 3d_{3/2}, with the 3d_{5/2} peak positioned at 444.40 eV and the 3d_{3/2} peak positioned at 451.96 eV. The P 2p core shows two peaks, one at 129.17 eV corresponding to P from InP and the other at 132.54 eV corresponding to oxidized P species. HR-XPS spectra of S 2p (161.86 eV) and spin-orbit split Zn 2p_{3/2} (1021.7 eV) and 4p_{1/2} (1044.76 eV) are also presented. The observed shift in the QD elemental peaks by 0.3 eV in the composites in comparison to the pure QDs is also shown in FIG. 18.

Theoretical Model

Within the simplest rate model, the number of excitons (N_{exc}) trapped in the QD, under constant illumination (steady-state condition), is given by:

−(γ_{exc}^{D}+γₜᵣₐₙₛ)N_{exc}^{D}+I_{D}=0 (S1)

−(γ_{exc}^{A})N_{exc}^{A}+γₜᵣₐₙₛN_{exc}^{D}+I_{A}=0 (S2)

where N_{exc}^{D(A)} is the donor (acceptor) number of excitons, I_{D(A)} is the exciton generation rate due to the light excitation, and γ_{exc}^{D(A)}=γ_{exc,rad}^{D(A)}+γ_{exc,non-rad}^{D(A)} is the donor (acceptor) exciton recombination rate in the absence of acceptor (donor). γ_{exc,rad}^{D(A)} and γ_{exc,non-rad}^{D(A)} are the radiative and nonradiative components of γ_{exc}^{D(A)}. γₜᵣₐₙₛ is the energy transfer rate between the donor and acceptor. By substituting N_{exc}^{D} from Eq. S1, Eq. S2 can be written as:

$$- ( {γ}_{exc}^{A} ) {N}_{exc}^{A} + {γ}_{trans} ( \frac{{I}_{D}}{{γ}_{exc}^{D} + {γ}_{trans}} ) + {I}_{A} = 0 \qquad ( S3 )$$

Assuming that I_{D}≅I_{A}=I₀, then Eq. S1 and S3 may be rearranged as follows:

$$\begin{matrix}- ( {γ}_{exc}^{D} + {γ}_{trans} ) {N}_{exc}^{D} + {I}_{0} = 0 & ( S 4 ) \\ - ( {γ}_{exc}^{A} ) ( \frac{{γ}_{exc}^{D} + {γ}_{trans}}{{γ}_{exc}^{D} + 2 {γ}_{trans}} ) {N}_{exc}^{A} + {I}_{0} = 0 & ( S 5 )\end{matrix}$$

From the last two equations, one can define

$$\begin{matrix}{γ}_{DA}^{D} = ( {γ}_{exc}^{D} + {γ}_{trans} ) & ( S 6 ) \\ {γ}_{DA}^{A} = ( {γ}_{exc}^{A} ) ( \frac{{γ}_{exc}^{D} + {γ}_{trans}}{{γ}_{exc}^{D} + 2 {γ}_{trans}} ) & ( S 7 )\end{matrix}$$

where γ_{DA}^{D(A)} is the donor (acceptor) exciton recombination rate in the presence of energy transfer. For the energy transfer rate between the D-A QD pair, we model Förster-type

$${γ}_{trans} = {{γ}_{D} ( \frac{{R}_{0}}{r} )}^{6} ,$$

where R₀ is the Förster radius for the D-A pair and r is the separation distance for the D-A QD pair. Therefore, Eq. S6 and S7 are given by:

$$\begin{matrix}{γ}_{DA}^{D} = {γ}_{exc}^{D} ( 1 + {( \frac{{R}_{0}}{r} )}^{6} ) & ( S 8 ) \\ {γ}_{DA}^{A} = {γ}_{exc}^{A} ( \frac{1 + {( \frac{{R}_{0}}{r} )}^{6}}{1 + 2 {( \frac{{R}_{0}}{r} )}^{6}} ) & ( S 9 )\end{matrix}$$

In terms of lifetimes,

$$\begin{matrix}{τ}_{DA}^{D} = \frac{{τ}_{exc}^{D}}{1 + {( \frac{{R}_{0}}{r} )}^{6}} & ( S 10 ) \\ {τ}_{DA}^{A} = {τ}_{exc}^{A} ( \frac{1 + 2 {( \frac{{R}_{0}}{r} )}^{6}}{1 + {( \frac{{R}_{0}}{r} )}^{6}} ) & ( S 11 )\end{matrix}$$

The Förster radius (in Å) is given by:

$${R}_{0} = 0.211 {( {κ}^{2} {n}^{- 4} {Q}_{D} J ( λ ) )}^{\frac{1}{6}} \qquad ( S 12 )$$

where κ² is the dipole orientation factor taken as ⅔ for a random orientation, n is the refractive index of the medium taken as the PMMA refractive index of 1.5, Q_{D} is the quantum efficiency of the donor quantum dots, taken as 5%, and J(λ) is the spectral overlap integral of the extinction coefficient of the acceptor and the donor emission spectra. Using the spectral values, the Förster radius is calculated to be 4.52 nm.

Whilst exemplary embodiments of the invention have been described in detail, many variations are possible within the scope of the invention as will be clear to a skilled reader.

1-30. (canceled)

31. A composite material comprising:
nanoparticles capped with a hydrophobic ligand dispersed within a polymer matrix, wherein the hydrophobic ligand is selected from (R¹)₃P, (R²)₃P(O), R³P(O)(OH)₂, R⁴NH₂, R⁵CO₂H and mixtures thereof, wherein:
R² to R³ each independently represents a C₈ to C₂₄ straight- or branched-chain alkyl group that is saturated or unsaturated;
R⁴ represents a C₁₄ to C₂₄ straight- or branched-chain alkyl group that is saturated or unsaturated; and
R⁵ represents a C₁₂ to C₂₄ straight- or branched-chain alkyl group that is saturated or unsaturated, wherein
the composite material is a free standing film that has a surface area of greater than 10 cm×10 cm and no substantial cracking or deterioration is observable in the free standing film.

32. The composite material of claim 31, wherein the film:
(a) is a multi-layered film having at least two layers; and/or
(b) has a surface area of greater than or equal to 50 cm×50 cm.

33. The composite material of claim 31, wherein a contact angle of a water droplet on the film is greater than or equal to 85° and less than 180° using a static sessile drop test.

34. The composite material of claim 31, wherein:
R¹ to R³ each independently represents a C₁₀ to C₁₆ straight- or branched-chain alkyl group that is saturated or unsaturated;
R⁴ represents a C₁₆ to C18 straight- or branched-chain alkyl group that is saturated or unsaturated; and
R⁵ represents a C₁₄ to C₁₈ straight- or branched-chain alkyl group that is saturated or unsaturated.

35. The composite material of claim 31, wherein R¹ to R⁵ each independently represent straight-chain alkyl groups.

36. The composite material of claim 31, wherein the hydrophobic ligand is selected from the group consisting of Myristic acid (MA), Stearic acid (SA), Trioctylphosphine oxide (TOPO), Tetradecylphosphonic acid (TDPA), Trioctylphosphine (TOP), Oleic acid (OA), Octylphosphonic acid (OPA), Hexadecylamine (HDA), Octadecylphosphonic acid (ODPA) and any combination thereof.

37. The composite material of claim 31, wherein the polymer matrix is selected from the group consisting of Polydimethylsiloxane (PDMS), Polymethylmethacrylate (PMMA), Polystyrene (PS), Polyethyleneglycol (PEG), Polyvinylalcohol (PVA) and any combination thereof.

38. The composite material of claim 31, wherein the nanoparticles are selected from the group consisting of quantum dots, semiconductor materials, metals and metal oxides.

39. The composite material of claim 38, wherein the quantum dots are selected from the group consisting of CdSe, CdS, CdTe, PbS, PbSe, ZnS, ZnSe, InP, InAs, CdHgTe, CdSe/CdS, CdSe/ZnS, CdSe/CdS/ZnS, CdTe/CdSe, CdTe/Cds, ZnSe/ZnS, CdTe/ZnS, InP/ZnS, InP/GaP/ZnS and any combination thereof.

40. The composite material of claim 31, wherein the quantum dots are selected from the group consisting of InP, InAs, InP/ZnS, InP/GaP/ZnS, the polymer matrix is polymethylmethacrylate and the fatty acid ligand is Myristic acid (MA) and/or Stearic acid (SA).

41. A composite material comprising InP/ZnS quantum dots capped with a fatty acid ligand dispersed within a polymer matrix of polymethylmethacrylate, wherein the composite material a free standing film that has a surface area of greater than 10 cm×10 cm and no substantial cracking or deterioration is observable in the free standing film.

42. A device suitable for light generation, light harvesting, light sensing and matching optoelectronic devices comprising a composite material of claim 31.

43. A method of making a composite material, comprising:
(a) mixing a polymer and nanoparticles capped with a hydrophobic ligand together in at least one solvent;
(b) depositing the resulting mixture, or a portion thereof, onto a substrate or mould;
(c) allowing the solvent to evaporate to form the composite material; and
(d) removing the composite material from the substrate or mould in substantially one piece,
wherein the hydrophobic ligand is selected from (R¹)₃P, (R²)₃P(O), R³P(O)(OH)₂, R⁴NH₂, R⁵CO₂H and mixtures thereof, the composite material a free standing film that has a surface area of greater than 10 cm×10 cm and no substantial cracking or deterioration is observable in the free standing film, wherein:
R¹ to R³ each independently represents a C₈ to C₂₄ straight- or branched-chain alkyl group that is saturated or unsaturated;
R⁴ represents a C₁₄ to C₂₄ straight- or branched-chain alkyl group that is saturated or unsaturated; and
R⁵ represents a C₁₂ to C₂₄ straight- or branched-chain alkyl group that is saturated or unsaturated.

44. The method of claim 43, wherein the solvent is selected from the group consisting of an alkane solvent, an aromatic solvent and a heterocyclic solvent.

45. The method of claim 43, wherein:
the polymer is PMMA and is dissolved in anisole; and/or
the nanoparticles are QDs suspended in toluene and/or hexane.

46. The method of claim 43, further comprising cleaning the nanoparticles with at least one solvent to remove excess organic ligands.

47. The method of claim 43, further comprising precleaning the substrate to remove any impurities from its surface.

48. The method of claim 43, wherein the mixture of polymer, nanoparticles and solvent is drop-cast onto the substrate at a pre-determined ratio of from 0.2 mL per 10 cm² to 2 mL per 10 cm².

49. The method of claim 43, wherein the QDs are selected from the group consisting of InP, InAs, InP/ZnS, InP/GaP/ZnS and the hydrophobic ligand is Myristic acid (MA) and/or Stearic acid (SA).

50. The method of claim 43, wherein the method forms a multi-layered film, further comprising:
(i) mixing a polymer and a nanoparticle capped with a hydrophobic ligand together in at least one solvent, said polymer and nanoparticle capped with a hydrophobic ligand;
(ii) depositing the resulting mixture, or a portion thereof, onto a previously formed composite material layer;
(iii) allowing the solvent to evaporate to form a further layer of composite material; and
(iv) repeating until the required number of layers have been deposited,
wherein (i) to (iv) follow (c) and precede (d).
